(19) United States
(12) Patent Application Publication
(10) Pub. No.: US 2026/0003952 A1
(43) Pub. Date: Jan. 1, 2026

(54) SYSTEMS AND METHODS FOR EXECUTING EXTERNAL SOFTWARE CODE

(71) Applicant: Atlassian Pty Ltd., Sydney (AU)

(72) Inventors: Richard Friend, Sydney (AU); Robert Englander, New York, NY (US)

(21) Appl. No.: 18/759,225

(22) Filed: Jun. 28, 2024

(51) Int. Cl. G06F 21/52

(52) U.S. Cl. CPC G06F 21/52; G06F 2221/033

(57) ABSTRACT

A method and system for executing external software code with a computer application. The method includes generating test data inputs based on values of interest in the external software code; generating simulations, including simulation parameters based on the values of interest in the external software code, to emulate the behavior of the computer application; executing the external software code in test iterations, using the test data inputs and simulations, in a sandbox environment isolated from a production environment; monitoring a line coverage of the external software code during the execution of the external software code; determining whether the line coverage of the external software code meets the predetermined completion threshold value; and in response to determining that the line coverage of the code meets the predetermined completion threshold value, verifying the external software code for use with the computer application in the production environment, and executing the external software code.

### TECHNICAL FIELD

Aspects of the present disclosure are directed to systems and methods for running software code, and in particular for verifying and executing external software code.

### BACKGROUND

Computer application products may provide various functionalities to users along with access to libraries and APIs of the products. Users may wish to extend the functionalities of some computer applications by importing their own software code into the computer application and executing the software code while having, at least partial, access to some of the libraries and APIs provided by the computer application. Providers of such computer applications are typically hesitant to allow customers to import their own software code within their computer application as they are typically unable to assess whether the imported software code is untrusted code (e.g., the type of software code that introduces bugs or issues in the original computer application causing the computer application to malfunction).

### SUMMARY

Example embodiments described herein are directed to computer implemented methods for executing external software code to be used with a computer application. The methods include generating one or more test data inputs based on values of interest in the external software code; generating one or more simulations, including simulation parameters based on the values of interest in the external software code, to emulate the behavior of the computer application; executing the external software code in one or more test iterations, using the test data inputs and simulations, in a sandbox environment isolated from a production environment in which the computer application is executing; monitoring a line coverage of the external software code during the execution of the external software code; determining whether the line coverage of the external software code meets a predetermined completion threshold value; in response to determining that the line coverage of the code meets the predetermined completion threshold value, verifying the external software code for use with the computer application in the production environment; and executing the external software code.

Some example embodiments are directed to a system. The system includes a processor, a display, an input device, and a non-transitory computer-readable medium comprising instructions, which when executed by the processor, cause the system to perform the method described above.

Other example embodiments are directed to non-transitory computer readable medium which when executed by a processor causes the processor to perform the method described above.

### BRIEF DESCRIPTION OF THE DRAWINGS

FIG. 1 is a block diagram of a networked environment in which various features of the present disclosure may be implemented.

FIG. 2 is a block diagram of a computer system with which various embodiments of the present disclosure may be implemented.

FIG. 3 is a flowchart depicting an example method for verifying external code according to embodiments of the present disclosure.

FIG. 4 is a flowchart depicting an example method for executing and verifying external code in one or more test iterations according to embodiments of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

Aspects of the present disclosure are described with respect to particular example computer applications, for example computer applications such as for cloud data hosting and management. It will be appreciated that these are merely used as examples and aspects of the present disclosure can be used with other computer applications without departing from the scope of the present disclosure.

The software code of a computer application typically progresses through four stages/environments-development, testing, staging and production. As the name suggests, in the development stage, the software code is developed and often pushed to an integrated development environment. Generally speaking, developers work on the software code locally, often updating it multiple times before pushing the latest updated version of the software code to the integrated development environment.

Once the latest software code edit is pushed to the integrated development environment, it typically passes to the testing stage (either automatically or manually) where various tests are run on the software code to ferret out any errors or bugs in the software code. Typically, the software code is tested in various environments (e.g., operating systems, programs, devices) it will ultimately be deployed in. Accordingly, a number of testing environment may be setup at this stage. Upon passing the testing stage, the software code enters the staging environment—where the behavior of the software code is tested with realistic data. A staging environment is similar to a production environment but is limited to a small number of people that can access and do further testing on the developed software code before it is released to the production environment. When the software code passes all these stages, it enters the production environment, also known as the live environment, where customers can interact directly with the computer application with the new version of the software code.

As discussed above, computer applications may provide various functionalities to users, along with access to underlying programs, libraries, and APIs.

Users may oftentimes wish to extend the functionality of the original computer application and/or add new functionalities to the original computer application by importing their own non-product software code (referred to as external code herein) into the software code of the original computer application. The ability to run external code within the same application process as the computer application may provide advantages in relation to performance and engineering efficiency as well as generally expanding the functionality of the computer application.

If execution of the external code only causes access to libraries and/or other data sources maintained by the user and/or only calls back to functions provided in the external code without in any way interacting with the compute or memory resources associated with the computer application, the service provider of the computer application may not need to worry about the execution of the external code as such execution may only affect the user that extended the functionality of the computer application for their own use. However, if execution of the external code causes access to libraries/APIs or other data sources maintained by the computer application provider and/or includes call backs to functions in the software code of the original computer application, any bugs/defects in the external code may cause issues in the original computer application. For example, the external code may expose the libraries and other data sources maintained by the computer application to security vulnerabilities and/or cause unintended errors within the software code of the original computer application. Accordingly, service providers are generally hesitant to run such external code (which is referred to as untrusted external code herein) within their computer applications. Furthermore, verifying untrusted external code may be challenging because it is time consuming, resource intensive, and/or challenging to provide sufficient confidence in the safety of the untrusted external code.

Accordingly, it may be desirable to have improved systems and methods for safely and securely verifying untrusted external code and allowing for the execution of such verified external code within the production environment of a computer application once the untrusted external code is verified.

Embodiments of the present disclosure provide systems and methods for verifying such untrusted external code. Broadley speaking, verifying the untrusted external code involves receiving the untrusted external code; executing the untrusted external code; monitoring the execution of the untrusted external code; determining the trustworthiness of the untrusted external code based on the monitoring; and verifying the untrusted external code if it is determined to be trustworthy. As used herein, reference to user code, untrusted code, or external code is reference to code which is the subject of verification and may be received directly or indirectly from a user. In the context of the present disclosure execution of the untrusted external code may cause (or involve) the execution of a program or process on a computer. The monitoring of the execution may involve the monitoring of the program or process and the monitoring of the computer, including detecting and recording events, and measuring and recording values.

In the following, an overview of an example network environment illustrating different systems involved in certain embodiments will be described, followed by a description of a computer system which can be configured in various ways to perform the embodiments/various features thereof as described herein. Following this, exemplary code verification methods will be described.

### Example Networked Environment

The techniques disclosed herein are described in the context of a product platform, for example, a cloud product platform for hosting and managing a computer application in the cloud. The product platform (e.g., a system including a computer application) may operate in a production environment and be configured to facilitate various operations, concerned with the computer application offering, to one or more users. In the context of the present disclosure, the operations may relevantly include receiving data, storing and retrieving data, transforming data, and accessing (or providing access to) one or more libraries and/or APIs. However, the techniques described herein may be implemented in platforms other than cloud product platforms, for example a dedicated code verification platform that may stand alone or interface with other platforms.

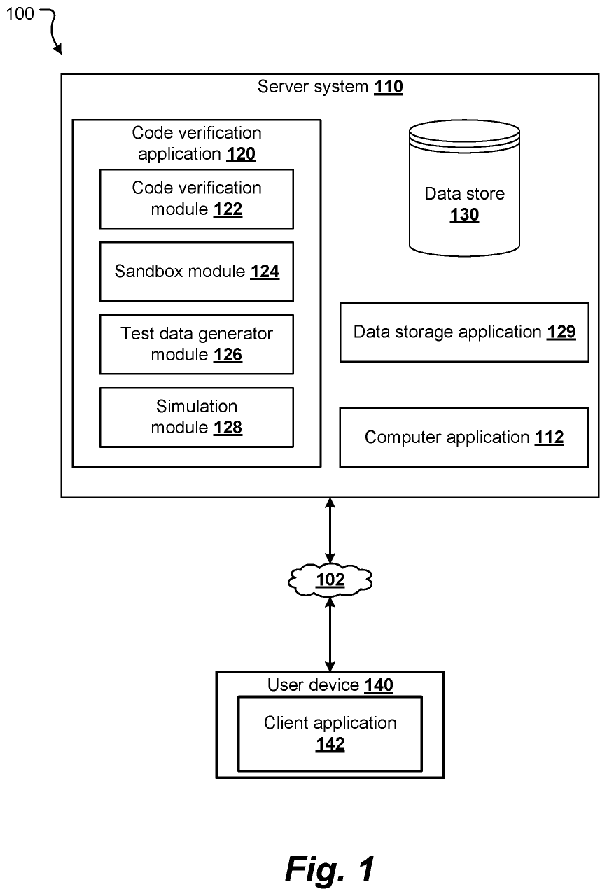

FIG. 1 illustrates an example networked environment 100 in which embodiments and features of the present disclosure are implemented. Example environment 100 includes a communications network 102 which interconnects a server system 110 and a user device 140.

The server system 110 includes a computer application 112; a code verification application 120; a data storage application 129; and a data store 130. The data store 130 is used for storing data related to functions performed by the computer application 112 and the code verification application 120, for example, external code data, computer application data, test data, APIs, and libraries.

The computer application 112 executes to provide server-side functionality for client applications (e.g., client application 142 discussed below) in respect of one or more products and/or services, for example, software products and/or services. Generally speaking, this involves receiving and responding to requests from client applications. The computer application 112 may be hosted by a web server (for interacting with web browser clients) or an application server (for interacting with dedicated application clients). Examples of products and functionalities provided by the computer application 112 may include cloud hosting; task planning; tracking; work management; collaboration; reporting; support; building; security; and other products and functionalities. Such products may provide various respective functionalities including providing access to one or more APIs, libraries, and/or integrated or partner applications. The computer application 112 may also provide access to or make use of code verification application 120. In addition to the specific functionality described herein, the computer application 112 (alone or in conjunction with other applications) may provide additional functions that are typically provided by server systems—for example user account creation and management, user authentication, and/or other server-side functions.

The code verification application 120 and its respective modules configure the server system 110 to provide code verification functionality to the computer application 112 and to provide server-side functionality for client applications (e.g., client application 142). Generally speaking, this involves receiving and responding to requests from the computer application 112 and/or client applications. The code verification application 120 may be hosted by a web server (for interacting with web browser clients) or an application server (for interacting with dedicated application clients).

In this example, the code verification application 120 includes a code verification module 122, a sandbox module 124, a test data generator module 126 and a simulation module 128.

Generally speaking, the code verification module 122 is configured to receive external code and verify the external code. The verification includes causing the external code to be executed, monitoring the execution of the external code; detecting parameters and the occurrence of events throughout the execution; and verifying the external code as trustworthy, or otherwise failing the verification, according to the detected parameters and events. The code verification module 122 may store and retrieve the external code for execution from data store 130 or in some embodiments may receive the external code from client application 142 (e.g., via computer application 112). The code verification module 122 may also store and retrieve records of verified external code and data on parameters, thresholds, and events in respect of verification, to and from, the data store 130.

The sandbox module 124 is configured to generate a sandbox environment to execute the external code within. The sandbox environment is a quarantined environment, for example, an environment isolated from production systems, such as the computer application 112, and from the data store 130. The sandbox module 124 may initialize and host one or more virtual machines, isolated processes, or contained processes within the server system 110 to implement the sandboxes. The sandbox module 124 may provide for the simulation and monitoring of network calls, disk accesses and other system calls that would emulate a computer application 112 as if it was within a production environment.

The test data generator module 126 is configured to generate test data as inputs to the execution of the external code. The test data may be provided as values for variables, values for parameters, and/or sequences of inputs to the external code. The test data generator module 126 may store and retrieve test data sets to and from the data store 130; may randomly generate test data; may generate test data based on feedback from the execution; and/or may parse the external code to identify variables and conditions for generating test data.

The simulation module 128 is configured to generate simulations of the behavior and outputs of a production system, for example, to emulate the computer application 112 within the sandbox environment. In general, a simulation is configured to simulate functions that the computer application 112 would perform, for example provide outputs in response to requests, inputs, and/or conditions. Simulations may include one or more mock components (mocks) which simulate the behavior of a component or system, for example, a mock API, mock service, mock function, mock database, and the like. Each mock may simulate a corresponding component of the computer application 112 according to particular parameters and conditions. The simulation module 128 may generate simulations by configuring and assembling various combinations of mocks. The simulation module 128 may store and retrieve simulation parameters and conditions, and mocks to and from the data store 130; may randomly generate simulations; may generate simulations based on feedback from the execution; and/or may parse the external code to identify variables and conditions for generating simulations.

In the present example, the code verification module 122, the sandbox module 124, the test data generator module 126, and the simulation module 128 have been described as modules of the code verification application 120—for example add-ons, plug-ins, or other software components that integrate with and expand the functionality of the code verification application 120. The functionality provided by one or more of these modules could, however, be performed by separate/stand-alone applications. As a further alternative, the functionality provided by one or more of these modules could be native functionality of the code verification application 120.

The data storage application 129 is configured to receive and process requests to persistently store and retrieve, to and from data store 130, data relevant to the operations performed/services provided by the computer application 112 and the code verification application 120. Such requests may be received from the computer application 112, the code verification application 120, other server environment applications, and/or (in some instances) directly from client applications such as 142. The data storage application 129 may, for example, be a relational database management application or an alternative application for storing and retrieving data from data store 130. Data relevant to the operations performed/services provided by the server system 110 may include, for example, product data; user data; user provided code (e.g., external code); APIs and libraries (production and simulated); verification data; testing data sets; production environment behavior sets; simulation parameters; and other data as described herein.

In certain embodiments, the server system 110 is a scalable system. Depending on demand from clients (and/or other performance requirements), compute nodes can be provisioned/de-provisioned on demand. As an example, if there is high client demand, additional code verification applications 120 (and/or computer applications 112) may be provisioned to cater for that demand. In this case, each functional component of the server system 110 may involve one or several applications running on the same or separate computer systems, each application including one or more application programs, libraries, APIs or other software that implements the functionality described herein.

The applications 112 and 120 may be server applications which execute to provide a client application endpoint that is accessible over communications network 102. To do so, the server applications 112 and 120 may include one or more application programs, libraries, APIs or other software elements that implement the features and functions that are described herein. For example, where server applications 112 and 120 serve web browser client applications the server applications 112 and 120 will be a web server which receives and responds to, for example, HTTP application protocol requests. Where server applications 112 and 120 serve native client applications, server applications 112 and 120 will be an application server configured to receive, process, and respond to API calls from those client applications. The server system 110 may include both web server and application server applications allowing it to interact with both web and native client applications.

While server system 110 has been illustrated with a single computer application 112 and a single code verification application 120, it may provide multiple computer applications 112 (e.g., one or more web server applications and/or one or more application server applications) and/or multiple code verification applications 120 (e.g., one or more web server applications and/or one or more application server applications). The applications 112 and 120 may be implemented as a collection of independent and autonomous application services (e.g., microservices). In this case, the constituent application services of applications 112 and 120 communicate amongst themselves, with other front end server applications, and/or with client application 142, via defined interfaces such as web APIs. In alternative embodiments, computer application 112 and code verification application 120 may be implemented as a single application (e.g., a monolithic application).

Data store 130 may be any appropriate data storage device (or set of devices), for example one or more non-transitory computer readable storage devices such as hard disks, solid state drives, tape drives, or alternative computer readable storage devices. Furthermore, while a single instance of data store 130 is described, server system 110 may include multiple instances of data storage.

The user device 140 includes a client application 142, which, when executed by the user device 140, configures the user device 140 to provide product functionality and/or code input functionality to allow users to do one or more of: access products and perform functionalities of the product and/or input external code for verification and execution within the production environment. This involves communicating with the server system 110 and, in particular, the computer application 112. In general, the computer application 112 will interact with the code verification application 120 to verify external code provided by client application 142. In alternative embodiments, the user device 140 and client application 142 may interface directly with the code verification application 120.

Users of user device 140 may include external end-users such as customers of the product, in respect of the computer application 112, as well as internal users, for example, developers and/or support users associated with the party that owns and operates the server environment 110. Users may further include partnered users who are affiliated with the party that owns and operates the server environment 110 and who provide auxiliary functionalities to (or via) the computer application 112. The client application 142 may be the same for external end-users, internal users, and/or partnered users. However, it is envisaged that the user device 140 and in particular the client application 142 may be different and operate differently for each of external end-users, internal users, and/or partnered users. For example, the client application 142 for internal users may be different to (e.g., may have more functionality when compared to) the client application 142 for external end-users, for example, internal users may be provided with more permissions and have access to more data of server system 110.

The client application 142 may be implemented in various ways. For example, the client application 142 may be web browser applications, which access the applications hosted by the server system 110 via appropriate uniform resource locators (URL) and communicate with the server system 110 via general world-wide-web protocols. In this case, the web browser application is configured to request, render and display UIs that conform to a markup language, and may be capable of internally executing browser-executable code, or other forms of code. Alternatively, the client applications 142 may be specific applications programmed to communicate with the server system 110 using defined application programming interface (API) calls.

In the present example, while a single user device 140 and a single client application 142 has been depicted, environment 100 will typically include multiple user devices 140 and multiple client applications 142, each configured to interact with the server system 110. User device 140 may be any form of computing device. Typically, user device 140 is a personal computing device—e.g., a desktop computer, laptop computer, tablet computer, smart phone, or other computing device.

Communications between the various systems in environment 100 are via the communications network 102. Communications network 102 may be a local area network, public network (e.g., the Internet), or a combination of both.

While environment 100 has been provided as an example, alternative system environments/architectures are possible.

The features and techniques described herein are implemented using one or more computer processing systems. For example, in networked environment 100 described above, user device 140 may be computer processing systems (for example, a personal computer, tablet/phone device, or other appropriate computer processing system) which is configured (or configurable) by hardware and/or software to offer client-side functionality. Similarly, the various functions performed by the server system 110 are performed by one or more computer processing systems (e.g., server computers or other computer processing systems).

### Example Computer System

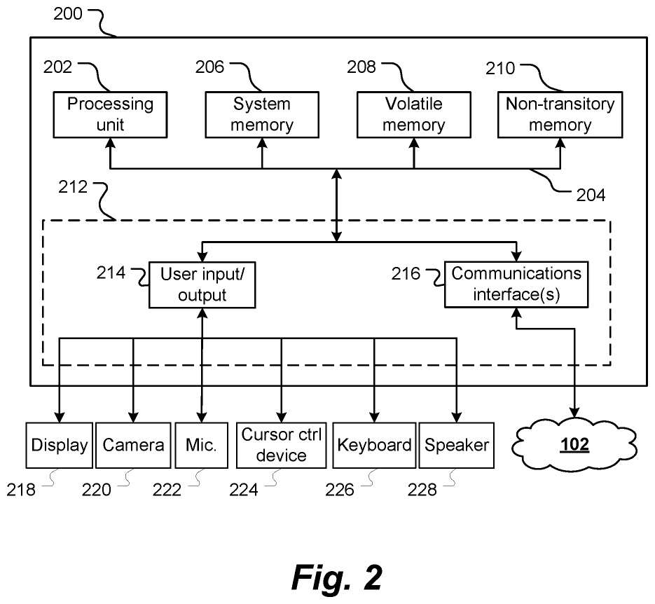

FIG. 2 is a block diagram of a computer processing system 200 configurable to perform various functions described herein. For example, systems 110 and/or 140 of FIG. 1 may be (or include) a computer processing system such as that shown in FIG. 2 (although alternative architectures are possible).

System 200 is a general-purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g., a central processing unit CPU, graphics processing unit GPU, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and usable by (either in a shared or dedicated manner) system 200.

Through a communications bus 204, the processing unit 202 is in data communication with a one or more machine readable storage (memory) devices which store instructions and/or data for controlling operation of the processing system 200. In this example system 200 includes a system memory 206 (e.g., a BIOS), volatile memory 208 (e.g., random access memory such as one or more DRAM modules), and non-volatile memory 210 (e.g., one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, connection between the device and system 200 may be via wired or wireless hardware and communication protocols, and may be a direct or an indirect (e.g., networked) connection.

Wired connection with other devices/networks may be by any appropriate standard or proprietary hardware and connectivity protocols. For example, system 200 may be configured for wired connection with other devices/communications networks by one or more of: Universal Serial Bus (USB); eSATA; Thunderbolt; Ethernet; HDMI. Other wired connections are possible.

Wireless connection with other devices/networks may similarly be by any appropriate standard or proprietary hardware and communications protocols. For example, system 200 may be configured for wireless connection with other devices/communications networks using one or more of: infrared; BlueTooth; WiFi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Depending on the particular system in question, devices to which system 200 connects include one or more input devices 214 to allow data to be input into/received by system 200 and one or more output devices 214 to allow data to be output by system 200. Example devices are described below, however it will be appreciated that not all computer processing systems will include all mentioned devices, and that additional and alternative devices to those mentioned may well be used.

For example, system 200 may include or connect to one or more input devices 214 by which information/data is input into (received by) system 200. Such input devices may, for example, include a keyboard, a pointing device (such as a mouse or trackpad), a touch screen, and/or other input devices. System 200 may also include or connect to one or more output devices 214 controlled by system 200 to output information. Such output devices may, for example, include one or more display devices (e.g., a LCD, LED, touch screen, or other display devices) and/or other output devices. System 200 may also include or connect to devices which act as both input and output devices, for example touch screen displays (which can receive touch signals/input and display/output data) and memory devices (from which data can be read and to which data can be written).

By way of example, where system 200 is an end user device (such as user device 140), it may include one or more of: a display 218 (which may be a touch screen display), a camera device 220, a microphone device 222 (which may be integrated with the camera device), a cursor control device 224 (e.g., a mouse, trackpad, or other cursor control device), a keyboard 226, one or more other input/output devices, and a speaker device 228.

System 200 also includes one or more communications interfaces 216 for communication with a network, such as network 102 of FIG. 1 (and/or a local network within the server system 110). Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (which may also be referred to as computer software or computer programs). Such applications include computer readable instructions and data which, when executed by processing unit 202, configure system 200 to receive, process, and output data. Instructions and data can be stored on non-transitory machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server system 110 includes one or more systems 200, which run a applications 112 and 120 to perform various operations described herein. Similarly, user device 140 runs a client application 142. In some cases part or all of a given computer-implemented method will be performed by system 110 itself, while in other cases processing may be performed by other devices (e.g., user device 140) in data communication with system 110.

### Example Methods

The following techniques are described with reference to a computer application 112 running a product in a production environment accessible by end-users and, at times, with particular reference to a cloud data hosting and management computer application. However, alternative products and applications are possible. Furthermore, the code verification system may be implemented as a standalone system instead of being implemented with a system also offering a computer application.

As one example, a service provider may provide access to a cloud data hosting and management computer application. The computer application may be provided to multiple users including external users, such as customers, as well as internal users and partnered users. A customer of the computer application may be a user belonging to a large enterprise organization with vast quantities of data they wish to migrate into the cloud as part of the service provider's computer application. The user may wish to inject their external code into the cloud data hosting and management computer application to facilitate migration of their data into the cloud, for example, to automate data migration aspects or include proprietary or custom logic for their data migration. Internal users may be, for example, support users who belong to (or are associated with) the same organization that operates the computer application, that is the service provider. Such support users may wish to inject external code into the computer application to resolve errors during data migrations and/or to test various operations. Partnered users may include users of organizations associated with the service provider, for example, users who belong to an organization that provides third party applications that are integrated with the computer application. Such partnered users may wish to inject external code into the computer application to control how their third-party applications are configured and/or updated within the computer application.

Users of the computer application 112 may provide untrusted external code for the service provider to verify as trustworthy before allowing the external code to be executed within the production environment. Accordingly, the code verification application 120 is configured to safely verify the untrusted external code such that it can be run in the trusted production environment. In this way, the code verification application 120 provides a process to transform untrusted external code into trusted code, allowing the external code to be accepted into the production environment including making permissions and accesses available to the external code. Allowing users to provide external code and verifying the external code for execution within a production environment allows users to extend the functionality of the computer application, increasing efficiency, and improving the functionalities of the computer application.

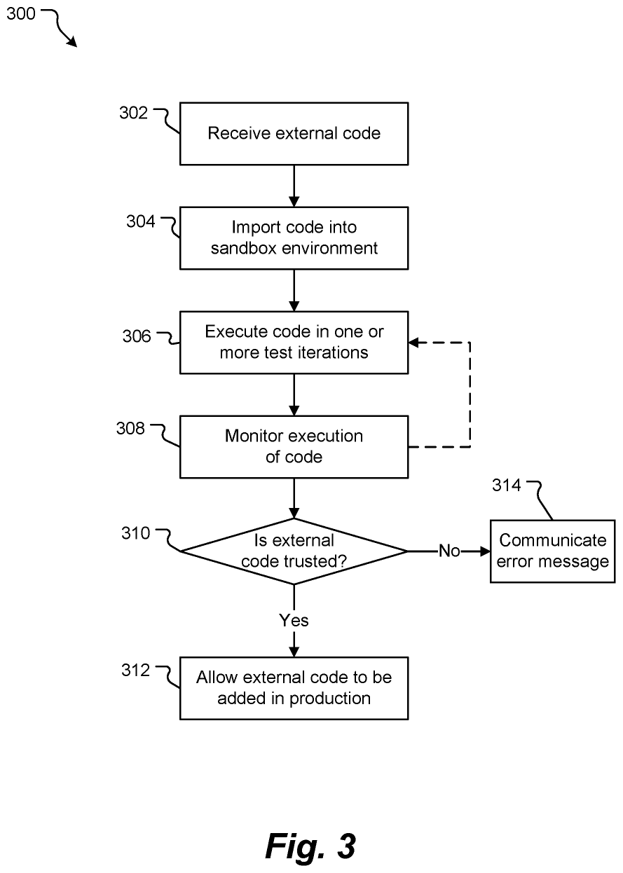

Turning to FIG. 3, a method 300 for verifying external code is described. The operations of method 300 are described as being performed primarily by the code verification application 120, as well as the computer application 112, running on the server system 110 and the client application 142 running on the user device 140. In alternative embodiments, the processing may be performed by one or more alternative systems (operating in conjunction with server system 110 and user device 140 or independently) and/or alternative applications running on those systems. The method 300 will generally be described with reference to a single user, although the method may be scaled to provide code verification functionality to multiple users. Additionally, for example, where a user is a customer belonging to a particular organization and that user has an instance of their code verified, once verified, the same verified code may be executable by other users of the organization and potentially by users of other organizations.

In general, a user may interact with system 110 via client application 142 running on their respective user device 140. The user may access the functionalities provided by the computer application 112 and perform various tasks and operations facilitated by the computer application 112. The computer application 112 may include programs operating within the application and/or may also provide access to APIs and libraries stored in data store 130. The user's access to such APIs and/or libraries may be controlled by the computer application 112, for example, based on a user's permission level or the like. During their use of the computer application 112, the user may wish to extend the functionality of the computer application 112 by executing their own external code within the computer application 112. Computer application 112 may provide an interface or API which allows the user to submit the external code they wish to add to the software code of the computer application.

Method 300 commences at step 302, where the code verification module 122 receives the external code, whether directly from a client application 142 or via computer application 112.

At step 304 the code verification module 122 imports the external code into a sandbox environment (sandbox, for short) hosted by the sandbox module 124. The sandbox module 124 may initialize the sandbox environment at this time or may have a sandbox environment running prior to step 304. The sandbox environment is a quarantined environment that is separate from, and has been isolated from, the production environment in which the latest version of the computer application 112 (along with its libraries and APIs) is executing. The sandbox environment is configured and hosted by the sandbox module 124 so as to prevent any code and actions caused by the execution of such code in the sandbox environment from impacting the computer application 112 and associated services and functionalities in the production environment. The sandbox module 124 may populate the sandbox environment with a default minimum data set to facilitate various test functionalities within the sandbox environment.

In some examples, the sandbox environment includes security and access controls to prevent unauthorized access to processes operating within the sandbox and also to prevent processes operating within the sandbox from accessing external processes such as those in the product environment. Different levels of security and access control may be configured according to different permission levels associated with respective users.

The sandbox environment may be implemented within the server system 110 as a virtual machine, as an isolated process, and/or within a container. Alternatively, in some embodiments the sandbox environment may implemented on a separate system other than server system 110. The sandbox environment is provided with resources including compute and memory resources. The resources of the sandbox environment may be set to emulate the equivalent level of computational resources of the computer application 112 when serving a user in the production environment. The sandbox environment may include a default set of minimal test data and/or test behaviors provided by the sandbox module 124. Alternatively, the sandbox may rely on test data and behaviors as provided by the test data generator module 126 and simulation module 128. The sandbox also includes monitoring and recording tools, for example sensor and logger tools, which may monitor the performance of the external code executed within the sandbox including monitoring resource utilization and the occurrence of events such as external network calls, disk accesses and/or system calls. For example, the sandbox module 124 may monitor memory consumption and CPU utilization to determine whether execution of the code exceeds one or more expected bounds.

At step 306, the external code is executed within the sandbox, by the sandbox module 124, in one or more test iterations. The test iterations may be executed on the basis of providing test data as inputs to the external code within the sandbox and the sandbox simulating the behavior of the computer application 112 such that the sandbox provides outputs back to the external code as would be expected to be received if the external code were actually running as part of the software code of the computer application 112 in the production environment. As mentioned above, the test data and simulation may be provided by the sandbox module 124 and/or from the test data generator module 126 and simulation module 128, discussed in more detail below.

In general, the test data generation module 126 generates test data to be input to the sandbox and/or applied as values of the external code to test the full extent of the external code including edge cases, potential error handling, and particular conditions of interest. The test data generator module 126 may generate one or more instances or sets of test data for use as inputs for executing the external code. In the present context, an input to the external code refers to a variable or parameter that may be provided as a value for an attribute in respect of the external code. The test data may be dynamically generated and/or modified based on the external code and/or feedback from execution of the code.

In some embodiments, the test data generator module 126 retrieves pre-generated test data sets from the data store 130. Pre-generated test data sets may be sets of inputs intended to be representative of a computer application data set, in order to test the execution of the external code based on inputs that may be expected within the computer application in the production environment. For example, test data may include simulated computer application data and/or a copy of computer application data (with appropriate anonymization) where applicable.

The test data generator module 126 may also randomly generate values as inputs for test iterations. Furthermore, the test data generator module 126 may generate specific values, for example, values of interest as inputs for test data. A value of interest may be a value that is intended or expected to cause a particular outcome when input to the external code. Examples of values of interest may be boundary values, conditional values, threshold values, and error values. Boundary values may be values at the boundaries of a variable and/or the edge cases, for example, minimum values, maximum values, unitary values, zero values and negative values. Conditional values may be values which satisfy any conditional statements in the external code, for example, values being true or values which yield a condition being true. Threshold values may be values that define a threshold or a quota within the code for example values that are just above, just at, or just below thresholds (e.g., 99%, 100%, 101%). In one example, in the case of code including a test for “if (a>10)”, threshold values may include values of 9, 10 and 11. Error values may be values outside the possible or expected range for a parameter, of an incorrect type or intended to cause an error in the code. Values of interest may also include null values.

To generate such specific test data, the test data generator module 126 may parse the received external code. In this way, the test data generator module 126 can inspect the external code to determine where particular data and data values are referenced, called, or otherwise utilized and may identify such values of interest. To illustrate this, consider the below example where the test data generator module 126 parses an example of external code and identifies the following lines of code:

```
if (counter <= 9)
{
  performAction( );
  counter ++;
}
```

In this example, the test data generator module 126 may identify that the counter variable is defined as an unsigned 8-bit integer and is used in a conditional statement where if the value of ‘counter’ is less than or equal to ‘9’, the code will perform some action and then increment the counter. Accordingly, the test data generator module 126 may generate test data to be input into the code as a value for ‘counter’. If, for example, in the production environment, counters are generally initialized at a particular value (e.g., 0 or 1), the test data generator module 126 may include that value in a test data set as a representative value for ‘counter’. The test data generator module 126 may also generate values for ‘counter’ according to the variable type, for example, generate random values for ‘counter’ between ‘0’ and ‘255’. Furthermore, values of ‘0’ and ‘255’ may be selected as boundary values (e.g., minimum and maximum values). Test data values of ‘256’, ‘−1’ and ‘abc’ may be included as error values (e.g., values incompatible with the variable type of an unsigned 8-bit integer) in the test data for ‘counter’. Test data values of ‘9’ and ‘10’ may be used as threshold values for ‘counter’. The test data generator module 126 may also include a value of ‘9’ and values less than ‘9’ as conditional values of interest on the basis that they satisfy the condition statement identified in the code. A null value of counter may also be included as a test data value. Whilst this example is in respect of an unsigned integer value as the object of a conditional if statement, the code parsing, and test data generation techniques are also applicable for alternative data types and conditions.

Next, at step 306, the external code is executed in one or more test iterations. Before doing so, the simulation module 128 generates and executes simulations that emulate behaviors of the computer application 112 in response to execution of the external code to test the full extent of the external code including edge cases, potential error handling, and particular conditions of interest. In the present context, a simulation refers to a simulation of the computer application 112 in the production environment such that behaviors and outputs of the external code executing within the sandbox are representative of the external code actually executing directly within the computer application 112.

The simulation module 128 may provide outputs in response to operations and/or calls caused by execution of the external code within the sandbox. Simulations may be provided as mocks of computer application functionality, features, and operations within the sandbox. Simulations and/or mocks may be dynamically generated and/or modified based on the external code and/or feedback from the execution of the code. For example, where a particular set of simulation conditions results in additional lines of external code being executed or external code performing new actions, the set of simulation conditions may be tuned and adapted to cause further lines of code to be executed and to continue along a line of testing the new actions.

In some embodiments, the simulation module 128 may retrieve pre-generated simulations and/or pre-generated mocks from data store 130. Pre-generated simulations may be provided directly to the sandbox when executing the external code in one or more test iterations. Pre-generated mocks may be assembled, in various combinations, into one or more simulations. Simulations (and mocks) may be configured to emulate various aspects expected from the computer application 112. The simulations may include function mocks which emulate the functions of the computer application and which return expected values should the external code executed within the sandbox attempt to call such functions of the actual computer application. The simulations may also include API mocks, mock databases and datasets (which may be provided by test data generator module 126) and other system mocks in order to simulate the behavior of the computer application 112 in response to different input scenarios and under different conditions.

As one example, where the computer application 112 regularly provides names in a set format, the simulation module 128 may generate a simulation and/or a mock which can respond to calls by the external code for the provision of such names. To illustrate, the computer application 112 may include (or provide access to) a getName function which returns a name as a string of between two and sixteen characters from a database. Accordingly, the simulation module 128 may configure the sandbox and/or provide a simulation or mock to run within the sandbox which responds to the external code executed in the sandbox which calls the getName function. In particular, the simulation module 128 may provide a simulation or getName mock which returns a name from a simulated dataset of names or randomly generates and outputs a string of between two and sixteen characters to emulate the format of the expected name output. Furthermore, the simulation module 128 may generate simulations and mocks which emulate specific behaviors and specific output values, for example, values of interest including outputs of boundary values, conditional values, and error values.

The simulation module 128 may also generate simulations which emulate behaviors of the computer application 112 when performing certain functions, for example, saving data, migrating data or updating a value in a database. In such simulations, the data and databases may be simulated and/or isolated within the sandbox. The simulation module 128 may generate simulations according to simulation data and product data stored in the data store 130 and/or may parse the received external code to generate simulations. To illustrate this, consider the below example where the simulation module 128 parses an example of external code and identifies the following lines of code:

if getVersion( ) == 3
{
performAction( );
}

In this example, the simulation module 128 may identify that the code includes a call to a getVersion function, wherein if the returned output is equal to ‘3’ some action is performed. Accordingly, the simulation module 128 may generate a simulation, which includes a mock to emulate the functionality of the getVersion function and, in particular, may generate a mock which returns a value of ‘3’ as the output of the emulated getVersion function on the basis that ‘3’ is a value of interest that satisfies a conditional statement. Additionally, the simulation module 128 may provide for the emulation of the performAction function. The simulation module 128 may further generate mocks which return values of ‘2’ and/or ‘4’ as values not equal to ‘3’ for use in alternative test iterations of the executed code. As another example, the simulation module 128 may also generate a simulation including a mock that returns the current version number of the computer application 112 as the output in response to the code calling the getVersion function.

Furthermore, continuing the above example in respect of the received code including a conditional if statement where if the value of ‘counter’ is less than or equal to ‘9’, an action is performed, the simulation module 128 may generate a simulation which causes the execution of the external code to behave in such a way as to increment the ‘counter’ from a value less than or equal to ‘9’ to a value greater than ‘9’. This may include the simulation module 128 interoperating with the test data generator module 126 to provide combinations of inputs and behaviors to test and exercise different scenarios and to trigger conditions of interest. For example, when test data values and/or simulation configurations result in additional code being executed (e.g., counter equaling 9 and/or get Version ( ) returning 3), such values and/or configurations may be retained for multiple iterations of code execution while other values and/or configurations are modified.

The code verification application 120 (via the test data generator module 126 and simulation module 128) is thus configured to determine a set of test data inputs and simulation conditions which result in all values of interest of user code being tested in order to test all of the code including edge cases and niche scenarios to ensure such instances would not cause negative impacts within a production environment. The code parsing and simulation techniques are also applicable in respect of alternative data types, alternative behaviors, alternative functions, and/or alternative conditions.

Thus, at step 306, the external code is executed, to run the program defined in the external code, in one or more test iterations within the sandbox environment utilizing such test data inputs and simulations as generated by the test data generator module 126 and simulation module 128. Depending on the requirements of the computer application 112 and code verification application 120, for example as configured by the service provider, the external code may be executed once, for a set number of iterations, for a set amount of time, or until a particular condition occurs. Throughout the iterations, the behavior of the external code, the number of lines of the external code executed in each iteration and the combinations of test data inputs and simulation configurations may be fed back into the sandbox to modify the test data inputs and simulation configurations.

At step 308, the execution of the external code is monitored by the code verification module 122. The monitoring may be via sensors and/or other monitoring tools included, by the sandbox module 124, in the sandbox environment. The monitoring may include, e.g., monitoring of the computational resource utilization caused by the execution of the external code; the occurrence of events, the behavior of the executed program, and the values of variables during execution of the external code. Whilst step 308 is depicted as subsequent to 306, the monitoring may occur in parallel with the execution of the test iterations. Furthermore, the code verification module 122 may interrupt (e.g., via the sandbox module 124) the execution of the external code including, for example, in response to the detection of an occurrence of an event, at a set point in the execution of the external code, and/or after a set amount of time. Additionally, or alternatively, an export of a monitoring log may be provided by sandbox module 124 at the completion of the execution of the external code and at step 308, the code verification module 122 may interrogate the log to identify resource utilization and/or logged events over the course of the execution.

In some examples, the code verification module 122 monitors the external code to detect, determine and/or measure one or more of:
Line coverage, including the number of lines, and which lines, of the external code are executed (in individual operations, in each test iteration, and over the total testing).
Execution time (of individual operations, of each iteration, and of the total testing).
The values of variables and the inputs and outputs of functions.
Processing load (e.g., CPU and/or GPU utilization) over the course of the execution(s) of the external code.
Memory consumption over the course of the execution(s) of the external code.
Network calls (internal and/or external).
File system calls and requests and/or attempts for disk accesses (e.g., of non-volatile memory 210 of system 110 and/or data store 130).
Attempts to fork processes and/or operations which may cause forking.

The above are non-limiting examples of monitoring and the code verification module 122 may monitor for more or less, and/or alternative parameters. For example, the code verification module 122 may additionally or alternatively monitor for other system calls by the execution of the external code and/or for the occurrence of particular values of interest in respect of particular variables or functions.

At 310 the code verification module 122 determines whether the code is trustworthy based on a comparison of the detected parameters, from the monitoring step 308, against one or more verification conditions. If the detected parameters satisfy the verification condition(s), the external code may be verified as trustworthy and allowed to be executed within the computer application 112 in the production environment. The code verification module 122 may attempt to verify (or determine the external code as being untrustworthy) at the completion of all testing of the external code; at the completion of each test iteration; in response to an interrupt, for example, based on the occurrence of an event; and/or after a set amount of time.

The code verification module 122 may verify the code as trustworthy at step 310 when the execution of the code satisfies a verification condition without triggering any failure conditions. In some embodiments, the verification condition may be a predetermined completion or line coverage threshold value, that is, the code may be verified when a predetermined threshold number or percentage of lines of the code have been executed without triggering any failure conditions. As used herein, line coverage or code coverage refers to the extent of execution of code in one or more test iterations based on the number of lines of external code which are (or have been) executed in one or more test iterations. The line coverage may be cumulative line coverage over the course of two or more test iterations. In one example, the verification condition may be complete (or 100%) line coverage, which provides that every possible line of code in the external code has been executed during testing to ensure that no negative impacts or unexpected occurrences would be caused by the execution of such external code. In other embodiments, the predetermined threshold line coverage may require execution of substantially all lines of external code. In alternative embodiments, the service provider may set a required extent of code completion (e.g., a predetermined number or percentage of lines of code) required to verify external code.

If the execution of the external code does not satisfy one or more verification conditions and/or triggers one or more failure conditions, the verification of the external code may fail at step 310. Failure conditions may include one or more of:
The execution time of the external code exceeds a time threshold.
The execution of the external code consumes memory which exceeds a memory threshold.
The execution of the external code attempts a prohibited system call, for example, an external network call, file system call or disk access.
The execution of the external code attempts to fork a process or would cause a fork of a process.
The execution of the external code causes an error, for example, causes a run time error, causes the simulation to exit, or otherwise causes the test iteration to fail.
The external code is executed for a number of iterations that exceeds an iteration threshold without the predetermined threshold line coverage.

The above failure conditions and thresholds are non-limiting examples and many additional and alternative conditions and thresholds are also possible. Additionally, failure conditions and thresholds may be combined, and varied based on such combinations. The failure conditions may be in respect of the execution of the external code for a single operation, a single test iteration, and/or over the complete testing of the external code throughout multiple iterations.

The time thresholds may be set by the service provider according to expected or desired run times of processes, for example, based on requirements and limitations of the production environment. Similarly, memory thresholds may be set such that where the execution of the external code consumes an excessive amount of memory compared to what would be expected from routine operation of the computer application 112, the verification may fail. Additionally, or alternatively, the service provider may set the thresholds according to limits which may ensure execution of the external code does not cause instability in server system 110 should the external code be executed in the production environment of computer application 112.

Furthermore, the thresholds may be varied depending upon the user who submitted the external code for verification, for example, internal support users or partnered users may have alternative conditions and/or thresholds applied to the verification of their code as compared to each other and/or compared to that of an external user. For example, an internal support user may be allowed a great amount of memory consumption and allowed a greater variety of permissible system calls within their code compared to the code of an external customer end-user on the basis of the internal support user having a different level of permission and trust from the service provider.

If, at step 310, the code verification module 122 determines that the external code is trustworthy, the method proceeds to step 312 where the external code may be verified and the code verification module 122 may store a record of the verification (along with a copy of the verified external code) to the data store 130. The external code may then be permitted to be deployed within the software code of the computer application in the production environment.

On the other hand, if the verification fails and the external code is not determined to be trustworthy at step 310, the method proceeds to step 314 where the code verification module 122 may store a record of the failed verification (and a copy of the tested external code) to the data store 130 and communicate an error or failure message to the user that submitted the external code. In some embodiments, repeated attempts of verifying the external code may be permitted, including allowing a user to modify and/or omit a portion of their external code which may have caused the failure of the verification.

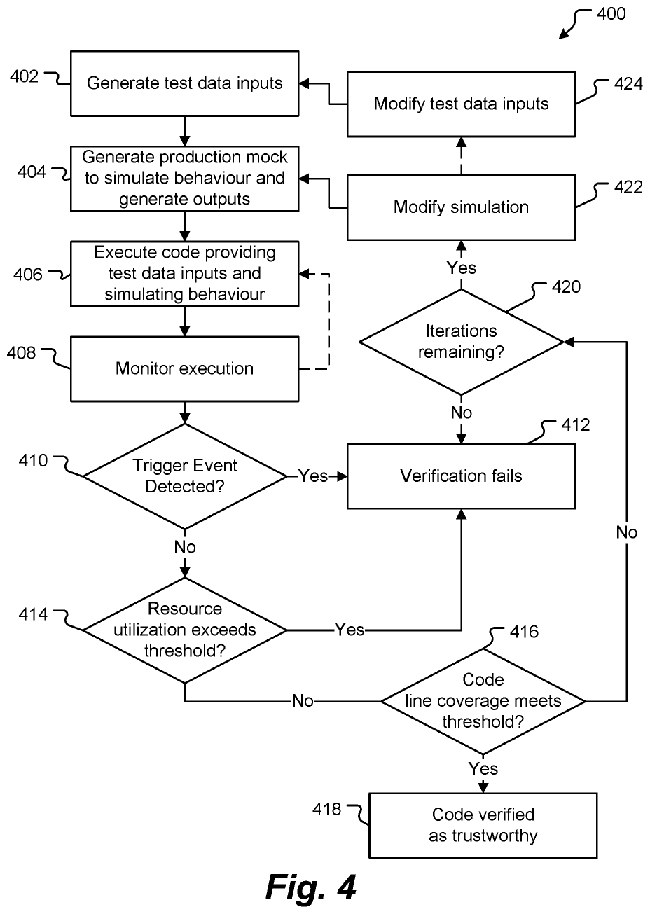

Referring now to FIG. 4, the operations of generating (and modifying) test data inputs, generating (and modifying) production simulations and mocks, and monitoring and testing code in a series of test iterations will be described to further illustrate techniques for the verification of external code. The method 400 is described in the context of the code verification module 122 having received the external code and imported the external code into a sandbox environment, for example, in a process similar to that of steps 302 and 304 of method 300.

Method 400 may then commence at step 402 with the generation of test data inputs by the test data generator module 126. Initially, the test data inputs may be generated, for example as outlined above, based on a standard set of test data, randomized test data, and/or test data values extracted from parsing the code for values of interest. At 404 the simulation module 128 generates mocks and simulations including such mocks to simulate the behavior and outputs of the computer application 112 and its associated APIs, libraries and datasets. Initially, the simulations may be generated, for example as outlined above, based on a standard simulation set, randomized simulation behaviors, and/or simulations based on values of interest extracted from parsing the external code.

At step 406, the external code is executed, for example, within a sandbox environment provided by sandbox module 124 as outlined above. Initially, the execution at 406 may be based on a default and/or initial set of inputs and simulation mocks. As will be explained further below, the test data inputs and simulations may be modified over the course of one or more additional test iterations.

At step 408, the execution of the external code is monitored, for example by the code verification module 122 as outlined above, to detect the extent of line coverage of the executed code, to detect values of parameters and to detect the occurrence of events during the execution of the external code.

At step 410, whether in response to an interrupt of the execution of the external code or by the code verification module 122 analyzing the monitoring and/or a log of the execution of the external code, it is determined whether any trigger events were detected. As described previously, trigger events may include the occurrence of an event which would satisfy a failure condition, for example, the code attempting a prohibited system call, such as an external network call, a file system call or a disk access. Trigger events may also include errors, exceptions, and attempts to fork processes. If it is determined that a trigger event occurred (e.g., ‘Yes’), the method proceeds to step 412 where the verification fails. At step 412, the method may then end without verifying the code as trustworthy. If no trigger events are detected (e.g., ‘No’) at step 410, the method 400 may continue to step 414.

At step 414, based on the monitoring of the execution of the external code it is determined whether the resource utilization during execution of the external code has exceeded a threshold. That is, for example, the code verification module 122 may determine whether the execution time is too long (e.g., exceeds a time threshold) and/or whether memory consumption is too high (e.g., exceeds a memory threshold). The code verification module 122 may also determine whether computational load, for example, as a percentage of available processing power has exceeded a threshold. The resource utilization thresholds may be in terms of a single operation, a single iteration, and/or the cumulation of multiple test iterations. Additionally, the resource utilization thresholds may be in terms of an instantaneous value and/or an average or aggregate value over time. If, at step 414, it is determined that resource utilization of the code execution has exceeded one or more thresholds (e.g., ‘Yes’), the method proceeds to step 412 where the verification fails. At step 412, the method may then end without verifying the code as trustworthy. If it is determined that the resource utilization has not exceeded any thresholds (e.g., ‘No’) at step 414, the method 400 may continue to step 416.

At 416, the code verification module 122 determines whether the code line coverage meets the predetermined threshold coverage. That is, the code verification module 122 determines whether the execution of the code (in the one or more test iterations) satisfies the verification condition of having executed a threshold number or percentage of lines of code in the code provided by the user. If it is determined that the code line coverage is meeting the predetermined threshold coverage (e.g., ‘Yes’) without any failure conditions (e.g., trigger events occurring or excessive resource consumption) having been detected, the method proceeds to 418 where the code is verified as trustworthy. As outlined above, verification of the code as trustworthy may include storing a record of the verification and a copy of the verified code to the data store 130. Alternatively, if at 416 the code line coverage does not meet the threshold coverage (e.g., ‘No’), the method continues to step 420 in one or more further loops of test iterations.

At step 420, it is determined whether there are iterations remaining for the testing of the external code. The number of test iterations can be configured by the service provider. In some embodiments, a set threshold of iterations, for example, 10 iterations may be allowed before the verification fails. In alternative embodiments, the number of iterations allowed may be based on the length and/or complexity of the external code. In some embodiments, the number of iterations could be potentially a relatively high number of iterations depending on the combinatorial complexity of the external code, for example, in excess of hundreds of test iterations. As a further example, whether further iterations are performed may depend on whether there are any remaining values of interest to test via test data inputs and/or simulations and/or combinations of inputs and simulations. In some embodiments, the number of test iterations may be configured based on the number of conditional statements in the code. For example, for external code with two binary conditional statements, the number of test iterations to test each line of code may be configured as four test iteration (i.e., 22). Additionally, or alternatively, test iterations may be executed for a set amount of time (e.g., a number of minutes, days, or hours). That is, the number of iterations may be constrained by a total iteration time rather than a set maximum number of iterations. The number of iterations and/or length of iteration may be set by the service provider based on the capacity of their systems and the extent of time and resources available for external code verification.

If, at step 420 no further iterations are remaining (e.g., ‘No’), the method proceeds to step 412 where the verification fails, and the method ends without verifying the code as trustworthy. Alternatively, if at step 420 it is determined that further iterations remain (e.g., ‘Yes’), the method continues to step 422.

At step 422, the simulation module 128 may generate further simulations and/or modify the simulation parameters for use in the execution of the external code in a further test iteration. The simulation parameters may be modified by progressing to another simulation amongst a set of simulations. Alternatively, particular values, conditions and behaviors of the simulation may be modified, randomized, or retained the same as the simulation of the previous test iteration. The modification of simulations may be performed by parsing the user code and extracting values, conditions, and behaviors of interest and/or based on the number of lines of code covered in the previous iteration. The modified simulation conditions and parameters may then be provided as mocks and simulations including such mocks to simulate the behavior and outputs of the computer application 112 and its associated APIs, libraries, and datasets as at step 404.

Similarly, at step 424, the test data generator module 126 may generate further test data and/or modify the test data inputs for use in the execution of the code in a further test iteration. The test data inputs may be modified by progressing to other test data amongst a set of test data. Alternatively, particular values of test data inputs may be modified, randomized, or retained the same as the corresponding input of the previous test iteration. The generation and modification of test data inputs may also be performed by parsing the external code and extracting values of interest and/or based on the number of lines of code covered by the previous test iteration. The modified test data inputs may then be provided as test data inputs as at step 402.

In each of the generation of further test data inputs and further simulations and/or the modification of test data inputs and simulations at steps 422 and 424, the modified or further test data inputs and simulations may be based on feedback from previous test iterations of the external code. For example, where a particular test data input value and/or simulation behavior resulted in new and/or additional lines of external code being executed (e.g., an increase in code coverage) that value and/or behavior may be maintained for a number of iterations while other values and/or behaviors are varied (e.g., randomized or varied based on other values of interest). The value may be maintained for a set number of iterations, for example based on the length and/or complexity of the external code. Alternatively, the number of iterations it is maintained for may depend on other factors, such as the number of other values of interest determined to depend on the maintained value, or until code coverage does not increase for a number of iterations. In this way, over the course of multiple test iterations, the test data generator module 126 and simulation module 128 search for a set of test data inputs and simulation parameters that cause an increasing line coverage of the external code.

To further illustrate this, consider the below example where the external code includes the following lines of code:

```
if name == “Reference”
{
  if getProjectID > 3
  {
    performAction( );
  }
}
```

In this example, the external code includes a conditional check for whether a name variable is equal to a “Reference” and, if so, proceeds to a further conditional check for whether a getProjectID function returns a value greater than ‘3’, if so, the external code performs some action. Accordingly, the test data generator module 126 may parse the external code and identify that the name “Reference” is a value of interest, and this value may be generated as a test data input (e.g., as at step 402) and injected into the sandbox for execution of the external code in a test iteration (e.g., as at step 406). The execution of the external code may be monitored (e.g., as at step 408) and it may be detected that the line coverage of the external code increases when the value of “Reference” is used as the value for name. That is, when the condition of name being equal to “Reference” is true in a test iteration, the code of “if getProjectID>3” is executed in that test iteration. Accordingly, when modifying the test data inputs and simulation at step 422 and step 424, the value of “Reference” for name may be retained as a test data input for one or more further iterations. Additionally, other test data inputs and simulation parameters may be modified. For example, at step 422 the simulation module 128 may modify the mock that is responsible for emulating the output in response to the getProjectID function. The mock may be modified such that it provides a random value as the output and further test iterations may be executed to test whether one of the random outputs result in further code coverage. Additionally, or alternatively, the simulation module 128 may parse the external code and identify an output of getProjectID being greater to ‘3’ is of interest.

Accordingly, for a further test iteration, the value of “Reference” for name may be retained and the simulation may be modified such that getProjectID returns an output greater than ‘3’. In such a further test iteration, because both condition in the external code are true, the above example code will perform some action, therefore that further test iteration will result in increased line coverage of the user code. Thus, the code verification application 120 executes the external code in multiple test iterations and receives feedback on each test iteration, including the number of lines covered by each iteration, and uses this feedback to modify parameters for further test iterations to search for a set of parameters that trigger ever greater line coverage. This process of executing test iterations; monitoring for changes in line coverage; and modifying test data inputs and simulations may be repeated in multiple iterative loops until code coverage meets the predetermined threshold coverage and the external code is verified, or until either a trigger event is detected; resource utilization exceeds a threshold; or no further iterations remain, and the verification fails.

Whilst the steps of method 400 are illustrated as a series or loop of sequential steps and decisions for the sake of explanation, alternative implementations are possible. For example, the generation of the simulation as at step 404 may be performed before or in parallel with generating test data inputs as at step 402. Similarly, the modification of the simulation and the test data inputs as at steps 422 and 424 may be performed simultaneously to each other.

Advantageously, the above-described techniques may test external code in a safe environment to determine whether the code performs any undesired operations, or causes any harm to, or negatively impacts, a computer application. Accordingly, embodiments disclosed herein, including the techniques described above, provide improved systems and methods for safely and securely verifying external code and allowing for the execution of such verified external code within a production environment of a computer application.

In the above embodiments, certain operations are described as being performed by the user device 140 (e.g., under control of the client application 142) and other operations are described as being performed at the server system 110. Variations are, however, possible. For example, in certain cases an operation described as being performed by user device 140 may be performed at the server system 110 and, similarly, an operation described as being performed at the server system 110 may be performed by the user device 140. Generally speaking, however, where user input is required such user input is initially received at user device 140 (by an input device thereof). Data representing that user input may be processed by one or more applications running on user device 140 or may be communicated to server system 110 for code verification application 120 running on the server system 110 to process. Similarly, data or information that is to be output to a user (e.g., via display, speaker, or other mechanism) will ultimately be generated by user device 140. The data/information that is output by the user device 140 may, however, be generated by client application 142 and/or the application 120 (and communicated to the user device 140 to be output).

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, one or more operations may be performed in parallel, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first threshold could be termed a second threshold or vice versa without departing from the scope of the described examples. Furthermore, when used to differentiate elements or features, a second threshold could exist without a first threshold. For example, a second threshold could be exceeded before a first threshold (or without a first threshold ever being exceeded).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A computer implemented method comprising:
receiving external software code that is to be executed with a computer application;
generating one or more test data inputs based on one or more values of interest in the external software code;
generating one or more simulations, including simulation parameters based on the one or more values of interest in the external software code, to emulate behavior of the computer application;
executing the external software code in one or more test iterations, using the test data inputs and simulations, in a sandbox environment isolated from a production environment in which the computer application is executing;
monitoring a line coverage of the external software code during the execution of the external software code in the sandbox environment;
determining whether the line coverage of the external software code meets a predetermined completion threshold value;
in response to determining that the line coverage of the code meets the predetermined completion threshold value, verifying the external software code for use with the computer application in the production environment; and
executing the external software code with the computer application.

2. The computer implemented method of claim 1, further comprising generating the sandbox environment, the sandbox environment including compute resources and memory resources for executing the external software code.

3. The computer implemented method of claim 2, further comprising:
monitoring utilization of the compute resources and/or the memory resources in the sandbox environment during execution of the external software code;
determining whether the utilization of the compute resources and/or the memory resources exceeds one or more resource utilization thresholds; and
in response to determining that the utilization of the compute resources and/or the memory resources exceeds the one or more resource utilization thresholds, failing the verification of the external software code.

4. The computer implemented method of claim 3, wherein:
the utilization of the compute resources and/or the memory resources includes one or more of execution time and memory consumption; and
the one or more resource utilization thresholds include one or more of a time threshold and a memory threshold.

5. The computer implemented method of claim 1, further comprising:
monitoring for occurrence of an event during the execution of the external software code;
determining that the event has occurred; and
in response to determining that the event has occurred, failing the verification of the external software code.

6. The computer implemented method of claim 5, wherein the event includes one or more of: a prohibited system call; a disk access; an attempt to fork a process; an operation that could cause a process to fork; and an error.

7. The computer implemented method of claim 1, wherein the one or more values of interest include one or more of boundary values, conditional values, threshold values, or error values.

8. The computer implemented method of claim 1, wherein the one or more values of interest are identified by parsing the external software code and identifying one or more values in the external software code as the one or more values of interest based on the external software code utilizing the one or more values to perform an operation.

9. The computer implemented method of claim 1, further comprising:
in response to determining that the line coverage of the external software code does not meet the predetermined completion threshold value, determining whether a number of test iterations performed exceeds a test iteration threshold;
in response to determining that the number of test iterations exceeds the test iteration threshold, failing the verification of the external software code; or
in response to determining that the number of test iterations does not exceed the test iteration threshold, executing the code in one or more further test iterations.

10. The computer implemented method of claim 9, further comprising:
modifying one or more of: one or more of the test data inputs; and one or more of the simulations; and
executing the external software code in the one or more further test iterations, using one or more modified test data inputs or one or more modified simulations.

11. The computer implemented method of claim 10, wherein modifying the test data inputs or simulations is based on a change in line coverage of the external software code between further test iterations.

12. The computer implemented method of claim 11, further comprising:
determining that a modified test data input or modified simulation parameter of a latest test iteration resulted in an increase in line coverage of the external software code compared to a previous iteration;
retaining the modified test data inputs or modified simulation parameter that resulted in the increase in line coverage for one or more further test iterations; and
modifying one or more other test data inputs or one or more other simulation parameters in the one or more further test iterations.

13. A computer processing system comprising:
a processing unit;
a display;
an input device; and
a non-transitory computer-readable medium storing instructions, which when executed by the processing unit, cause the processing unit to:
receive external software code that is to be executed with a computer application;
generate one or more test data inputs based on one or more values of interest in the external software code;
generate one or more simulations, including simulation parameters based on the one or more values of interest in the external software code, to emulate behavior of the computer application;
execute the external software code in one or more test iterations, using the test data inputs and simulations, in a sandbox environment isolated from a production environment in which the computer application is executing;
monitor a line coverage of the external software code during the execution of the external software code in the sandbox environment including computer resources and memory resources for executing the external software code;
determine whether the line coverage of the external software code meets a predetermined completion threshold value;
in response to determining that the line coverage of the code meets the predetermined completion threshold value, verify the external software code for use with the computer application in the production environment; and
execute the external software code with the computer application.

14. The computer processing system of claim 13, further comprising instructions, which when executed by the processing unit, cause the processing unit to:
monitor utilization of the compute resources and/or the memory resources in the sandbox environment during execution of the external software code;
determine whether the utilization of the compute resources and/or the memory resources exceeds one or more resource utilization thresholds; and
in response to determining that the utilization of the compute resources and/or the memory resources exceeds the one or more resource utilization thresholds, fail the verification of the external software code.

15. The computer processing system of claim 13, further comprising instructions, which when executed by the processing unit, cause the processing unit to:
monitor for occurrence of an event during the execution of the external software code;
determine that the event has occurred; and
in response to determining that the event has occurred, fail the verification of the external software code.

16. The computer processing system of claim 13, further comprising instructions, which when executed by the processing unit, cause the processing unit to:
in response to determining that the line coverage of the external software code does not meet the predetermined completion threshold value, determine whether a number of test iterations performed exceeds a test iteration threshold;
in response to determining that the number of test iterations exceeds the test iteration threshold, fail the verification of the external software code; or
in response to determining that the number of test iterations does not exceed the test iteration threshold, execute the code in one or more further test iterations.

17. The computer processing system of claim 16, further comprising instructions, which when executed by the processing unit, cause the processing unit to:
modify one or more of: one or more of the test data inputs; and one or more of the simulations; and
execute the external software code in the one or more further test iterations, using one or more modified test data inputs or one or more modified simulations.

18. The computer processing system of claim 13, wherein modifying the test data inputs or simulations is based on a change in line coverage of the external software code between further test iterations.

19. The computer processing system of claim 18, further comprising instructions, which when executed by the processing unit, cause the processing unit to:
determine that a modified test data input or modified simulation parameter of a latest test iteration resulted in an increase in line coverage of the external software code compared to a previous iteration;
retain the modified test data inputs or modified simulation parameter that resulted in the increase in line coverage for one or more further test iterations; and
modify one or more other test data inputs or one or more other simulation parameters in the one or more further test iterations.

20. A non-transitory medium storing instructions executable by processing unit to cause the processing unit to:
receive external software code that is to be executed with a computer application;
generate one or more test data inputs based on one or more values of interest in the external software code;
generate one or more simulations, including simulation parameters based on the one or more values of interest in the external software code, to emulate behavior of the computer application;
execute the external software code in one or more test iterations, using the test data inputs and simulations, in a sandbox environment isolated from a production environment in which the computer application is executing;
monitor a line coverage of the external software code during the execution of the external software code in the sandbox environment including computer resources and memory resources for executing the external software code;
determine whether the line coverage of the external software code meets a predetermined completion threshold value;
in response to determining that the line coverage of the code meets the predetermined completion threshold value, verify the external software code for use with the computer application in the production environment; and
execute the external software code with the computer application.
